(19) United States
(12) Patent Application Publication
(10) Pub. No.: US 2010/0013914 A1
(43) Pub. Date: Jan. 21, 2010

(54) IN-VIVO SENSING DEVICE AND METHOD FOR COMMUNICATING BETWEEN IMAGERS AND PROCESSOR THEREOF

(76) Inventors: Ido Bettesh, Haifa (IL); Semion Khait, Tiberias (IL); Micha Nisani, Nesher (IL); Zvika Gilad, Haifa (IL)

Correspondence Address: Pearl Cohen Zedek Latzer, LLP, 1500 Broadway, 12th Floor, New York, NY, 10036, US

(21) Appl. No.: 12/295,428

(22) PCT Filed: Mar. 25, 2007
(86) PCT No.: PCT/IL07/00386

§ 371 Date: Jul. 17, 2009

Related U.S. Application Data
(60) Provisional application No. 60/787,188, filed on Mar. 30, 2006.

(51) Int. Cl. H04N 7/18

(52) U.S. Cl. 348/77; 348/E07.085

(57) ABSTRACT

An in-vivo sensing device having multiple imagers controlled by a single processor and a method for communicating between the processor and the imagers. The processor and imagers are connected via common data and control busses, instead of by direct separate conducting lines thereby reducing the number of pins on the processor and the corresponding number of conducting lines.

### FIELD OF THE INVENTION

The present invention relates to an in-vivo sensing device having a plurality of imagers controlled by a single processor and a method for communicating between the processor and the imagers.

### BACKGROUND OF THE INVENTION

In-vivo devices, such as, for example, swallowable capsules, may be capable of gathering information regarding a body lumen while inside the body lumen. Such information may be, for example, a stream of images of the body lumen and/or measurements of parameters that are of medical concern, such as, for example, pH.

In an in-vivo sensing device having a single imager, the imager may receive input data in the form of control commands or instructions from a processor and in return may transmit sensed data, such as image data, to the processor. Data may be transferred between the imager and processor via input and output ports, which are realized in hardware by pins. If the imager has M pins, then the processor should have at least M pins, with each of the M pins of the imager connected to a corresponding pin of the processor by an electrically conducting line.

A single imager may have a given field of view. If it is desired to receive images over a field of view that is larger than that provided by a single imager, or if it is desired to receive images from a number of different directions, then more than one imager may be required. If N imagers are used, then the processor may need at least N×M pins to communicate with the M imagers and there will be a corresponding number of conducting lines connecting the processor and the imagers.

This increase in the number of pins on the processor and the corresponding increase in conducting lines connecting the processor and the imagers may result in an undesirable increase in room occupied by these constituents in the in-vivo sensing device and an increase in power usage. In addition, the increase in conducting lines also increases the level of complexity and therefore increases production costs. Therefore, it is desirable to keep the number of pins on the processor to a minimum.

### SUMMARY OF THE INVENTION

There is provided, in accordance with some embodiments of the present invention, an in-vivo imaging device having a plurality of imagers controlled by a single processor. There is also provided, in accordance with some embodiments of the present invention, a method for communicating between the processor and the imagers. The processor and imagers are electrically connected via a common data bus and a common control bus, instead of by direct separate conducting lines thereby reducing the number of pins on the processor and the corresponding number of conducting lines. Consequently, in comparison to direct electrical connection of the processor and imagers, there is a decrease in the room occupied by the conducting lines, a decrease in power usage and a decrease in the level of complexity of the associated electrical circuit.

In accordance with some embodiments, the processor may be an Application Specific Integrated Circuit (ASIC). By using a single common control bus to transmit control signals from the processor to the imagers, and a single common data bus to transmit data from the imagers to the processor and from the processor to the imagers, the number of pins required on the ASIC is reduced, in comparison to the case in which the imagers and the ASIC are directly connected by electrically conducting lines. For example, instead of having at least N×M pins on the processor, where N is the number of imagers and M is the number of pins on each imager, the processor may need only at least M pins.

Although a single common data bus and a single common control bus is used, the processor may uniquely communicate with a specific imager. The unique communication with a specific imager may be done, for example, by providing every imager with its own identity information. In order to communicate with a specific imager, the control signals transmitted on the common bus may include the identity information of the specific imager. Each imager may ignore control signals which do not include its unique identity information. Therefore, the control signals which include identity information of a specific imager may be addressed to only this specific imager. By including identity information of specific imagers in the communication, it is possible for the processor to communicate either with a specific imager, a specific group of imagers, with all imagers cyclically or with all the imagers simultaneously. This is advantageous when groups of imagers may have joint tasks. As a nonbinding example, a capsule for capsule endoscopy may have plurality of imagers distributed over different locations of the capsule. For example, a group of imagers at one end of the capsule, another group at the other end, and a third group distributed along the surface of the capsule between both ends of the capsule. The third group of imagers may possibly be partitioned into subgroups. For example, a first group of imagers along a first side of the capsule and a second group of imagers along a second side of the capsule. The processor may be able to communicate with each group separately.

Each imager may be connected to the processor with a separate reset line. The system may further comprise certain elements such as a power source or a clock signal source, which may have to be stabilized before the imagers start working. The processor may initiate the imagers at the right moment after all the elements are stabilized using the separate reset lines. A separate reset line may facilitate easy initialization of a specific imager. A separate reset line may enable easy activation of a specific idle imager, and may facilitate easy synchronization of the imagers among themselves and with the processor. A separate reset line may enable individual communication with specific imagers. In accordance with some embodiments, a single reset line may connect between all the imagers and the processor. In such embodiments, all the imagers may be reset simultaneously. In accordance with some embodiments, reset may also be performed through the common control bus by a command which is addressed to a specific imager using the unique identity information of that imager.

The usage of common buses may require synchronization of the imagers to avoid confusion. A nonbinding example of a communication sequence implementing this requirement may be as follows:
(i) reset all imagers,
(ii) communicate and receive data from a group of imagers using the identity information associated with the imagers of said group.
(iii) if one or more imagers of said group need to be reset, reset those imagers and return to (ii).
(iv) if data from other imagers is needed, update the identity information and return to (ii). If no change of imagers is needed return to (ii).

Any group of imagers may consist of at least one imager.

### BRIEF DESCRIPTION OF THE FIGURES

The present invention will be understood and appreciated more fully from the following detailed description taken in conjunction with the figures in which:

FIG. 1 is an illustrative schematic side view of an in-vivo imaging device with imagers at one end;

FIG. 2 is an illustrative schematic side view of an in-vivo imaging device with imagers at both ends, according to some embodiments of the present invention:

FIG. 3 is an illustrative schematic side view of an in-vivo imaging device with imagers at both ends and with imagers located behind the central cylindrical portion between the ends, according to some embodiments of the present invention;

FIG. 4 is an illustrative schematic diagram showing the electrical connection between the processor and four imagers using a control bus and a data bus, according to some embodiments of the present invention; and

FIG. 5 is a flow chart illustrating a data transfer sequence according to some embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

The following description is presented to enable one of ordinary skill in the art to make and use the invention as provided in the context of a particular application and its requirements Various modifications to the described embodiments will be apparent to those with skill in the art and the general principles defined herein may be applied to other embodiments. Therefore, the present invention is not intended to be limited to the particular embodiments shown and described, but is to be accorded the widest scope consistent with the principles and novel features herein disclosed. In the following detailed description, numerous specific details are set forth in order to provide a thorough understanding of the present invention. However, it will be understood by those skilled in the art that the present invention may be practiced without these specific details. In other instances, well-known methods, procedures, and components have not been described in detail so as not to obscure the present invention.

Embodiments of the device and method of the present invention are preferably used in conjunction with an imaging device such as described in U.S. Patent Application Publication No. 2002/0109774 entitled “System and Method Wide Field Imaging of Body Lumens,” which is incorporated herein by reference. The device and method of the present invention may also be used with an imaging device such as described in U.S. Pat. No. 5,604,531 entitled “In Vivo Video Camera System” and/or in U.S. Pat. No. 7,009,634 entitled “Device For In Vivo Imaging”, both of which are hereby incorporated by reference. However, the device and method according to the present invention may be used with any device providing imaging and other data from a body lumen or cavity.

The system according to some embodiments of the present invention is an in-vivo imaging system having a plurality of imagers controlled by a single processor. The system enables communication between the processor and the imagers through common buses, which may reduce the number of pins on the processor and of conducting lines, and therefore may prevent increase in room occupied. The size of the room occupied is especially important when dealing with in-vivo devices. Therefore, a method and system for reduction of pins, which prevent increase in room occupied, is desirable.

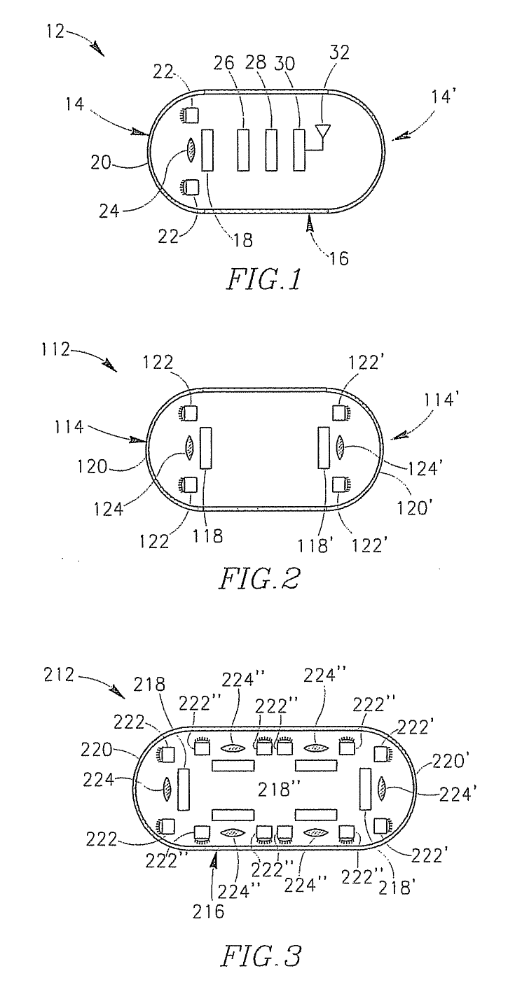

Reference is made to FIG. 1, showing in-vivo imaging device 12 according to embodiments of the present invention. In some embodiments, the in-vivo imaging device 12 may be a wireless device. In some embodiments, the in-vivo imaging device 12 may be autonomous. In some embodiments, the in-vivo imaging device 12 may be a swallowable capsule for imaging the gastrointestinal (GI) tract of a patient. However, other body lumens or cavities may be imaged or examined with the in-vivo imaging device 12.

The in-vivo imaging device 12 ma) be generally cylindrical in shape with dome-like ends 14, 14′ and a cylindrical portion 16, therebetween. The in-vivo imaging device 11 may include at least one imager 18 for capturing image data in the form of image frames of images of an in-vivo site such as a gastrointestinal tract, or other body lumens or cavities, as the in-vivo imaging device 12 traverses therethrough. The in-vivo imaging device 12 may also include a viewing window 20 at least one of its ends 14, one or more illumination sources 22, an optical system 24, a power supply such as a battery 26, a processor 28, a transceiver 30, and an antenna 32 connected to the transceiver 30. The illumination sources 22 may be Light Emitting Diodes (LED) or other suitable illumination sources for illuminating a target area from which image flames are to be captured. The imager 18 may be a CMOS imager. Alternatively, other imagers may be used, e.g. a CCD. The image data and or other data captured by the in-vivo imaging device 12 may be transmitted as a data signal by wireless connection, e.g. by wireless communication channel, by the transmitter 30 via the antenna 32, from the in-vivo imaging device 12 and received by an external recorder. The processor 28 may be connected to the illumination sources 22 and to the imager 18 to synchronize the illumination of the in-vivo site by the illumination sources 22 with the capturing of images by the imager 18. A non-exhaustive list of examples of the processor 28 includes a micro-controller, a micro-processor, a central processing unit (CPU), a digital signal processor (DSP), a reduced instruction set computer (RISC), a complex instruction set computer (CISC), and the like. The processor 28 may be part of an application specific integrated circuit (ASIC), may be a part of an application specific standard product (ASSP), may be part of a field programmable gate array (FPGA), or may be part of a complex programmable logic device (CPLD). In accordance with some embodiments, the processor and the transceiver may be implemented in one component.

When viewing certain lumens or cavities, it may be advantageous to have more than one imager. Reference is now made to FIG. 2 showing an illustrative schematic side view of an in-vivo imaging device 112 with imagers 118, 118′ at both ends or proximal to both ends 114, 114′, located behind respective viewing windows 120, 120′ in accordance with embodiments of the present invention. Each imager 118, 118′ has associated illumination sources 122, 122′ and an associated optical system 124, 124′. In FIG. 3, various electrical and electronic devices (shorn in FIG. 1 as, battery 26, processor 28, transceiver 30 and antenna 32) are not shown for the sake of clarity. Having imagers 118, 118′ at both ends of the in-vivo imaging device 12 allows it to capture images in both forward and rearward directions, relative to the direction of motion, as it traverses the gastrointestinal tract or other body lumens.

Reference is now made to FIG. 3 showing an illustrative schematic side view of an in-vivo imaging device 212 with imagers 218, 218′ at both ends or proximal to both ends, located behind respective viewing windows 220, 220′ and with imagers 218″ located behind the central cylindrical portion 216, which also forms a viewing window, in accordance with embodiments of the present invention. Each imager 218, 218′, 218″ has associated illumination sources 222, 222′, 222″ and an associated optical system 224, 224′, 224″ In FIG. 3, as in FIG. 2, various electrical and electronic devices (shown in FIG. 1 as, battery 26, processor 28, transceiver 30 and antenna 32) are not shown for the sake of clarity.

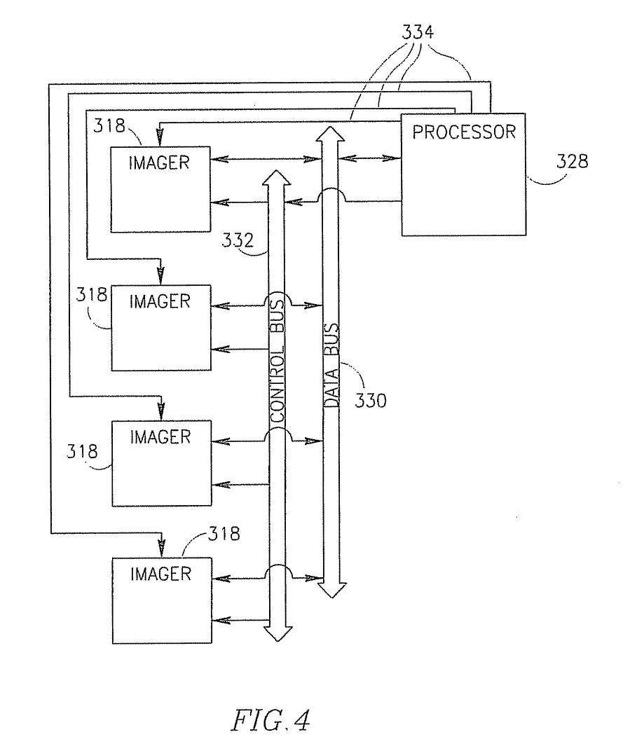

Reference is now made to FIG. 4, which is a schematic diagram showing the electrical connections between four imagers 318 and a processor 328, according to some embodiments of the present invention. Four imagers have been chosen for convenience of illustration only. The number of imagers is not limited to four and can be substantially any number. The imagers 318 and the processor 328 may be located in an in-vivo imaging device, such as the in-vivo imaging devices 12, 112, 212 described herein and may be spatially distributed inside the in-vivo imaging device in any desired manner.

The processor 328 and the imagers 318 may communicate with each other over a common data bus 330 and over a common control bus 332, In some embodiments, each imager 318 may be connected to the processor 328 with a separate reset line 334. In some embodiments, all the imagers 318 are connected to the processor 328 by a single reset line. The common control bus 332 may be used to communicate control signals from the processor 328 to the imagers 318. In some embodiments, a reset signal may be transmitted from the processor 328 to the imagers 318 over the common control bus 332. In such embodiments, the reset lines 334 may not be required. If desired, all the imagers 318 may be reset simultaneously. The data bus 330 may be used for the transmission of data from the imagers 318 to the processor 328 and in the other direction from the processor 328 to the imagers 318.

If separate conducting lines were to be used to connect between the processor and the imagers 318 instead of the data and control buses 330, 332 then the processor 328 would have at least twelve pins for at least twelve separate lines, comprising: four lines for connecting the processor 328 to each imager 318a for data transmission; four lines for connecting the processor 328 to each imager 318a for control signals transmission; and four lines for connecting the processor 328 to each imager 318a for reset commands. On the other hand, by using the data and control buses 330, 332 the processor 328 requires only at least six pins for at least six separate lines, comprising one line for connecting the processor 328 to the data bus 330 for data transmission to each imager 318a; one line for connecting the processor 328 to the control bus 332 for control signals transmission to each imager 318a; and four lines for connecting the processor 328 to each imager 318a for reset commands.

For the sake of illustration only and in order not to overburden FIG. 4 with lines, only three connecting conducting lines are shown for each imager 318, with each imager having a pin associated with each conducting line. In practice, each imager 318 may have more than three pins, each connected to the processor 328 by a conducting line, via the common data bus 330, to a corresponding processor pin, each line serving to carry a specific shared signal. A non-exhaustive and non-binding list of possible shared signals is given below.
(i) CLOCK—the driving clock of the processor
(ii) TRANSMISSION VALID—defines when data transmission occurs
(iii) LIGHT—defines the illumination time of the illumination sources
(iv) IMAGE DATA—captured image data
(v) SDATA—transferring commands to the Imagers and also for reading internal values from within the Imagers.
(vi) SHUT DOWN—for performing halt operation and hardware reset of imagers.

Although single common buses 330, 332 are used, the processor 328 may uniquely communicate with a specific imager. The unique communication with a specific imager may be done, for example, by providing each imager 318 with its own identity information. In order to communicate with a specific imager, the control signals transmitted over the common control bus 332 may include the identity information of the specific imager. Each imager 318 can ignore control signals which do not include its unique identity information. Therefore, the control signals which include identity information of a specific imager may be addressed only to this specific image. By including identity information of specific imagers in the communication, it is possible for the processor 328 to communicate with a specific imager a specific group of imagers or with all imagers 318. Communicating with two or more imagers 318 may be done cyclically. This is advantageous when groups of imagers may have joint tasks. As a nonbinding example, a capsule for capsule endoscopy may have a plurality of imagers distributed over different locations of the capsule. For example, a group of imagers at one end of the capsule, another group at the other end, and a third group distributed along the surface of the capsule between both ends of the capsule. The third group of imagers may possibly be partitioned into subgroups. For example, a first group of imagers along a first side of the capsule and a second group of imagers along a second side of the capsule. The processor may be able to communicate with each group separately in order to receive images from members of this group. Distribution of imagers along different parts of the capsule may provide different point of views of the observed tissue, or a broader field of view. Imagers on different parts of the capsule may perform also additional different functions such as distance measurements.

The in-vivo imaging device 12 may include certain components which may have to be stabilized before the imagers 318 start working. Such components may include power sources, such as the battery shown in FIG. 1 and clocks (not shomr). The processor 328 may initiate the imagers 318 at the right moment after all the components are stabilized using the separate reset lines 334. Each of the separate reset lines 334 may facilitate easy initialization of a specific imager. Each of the separate reset lines 334 may enable easy activation of a specific idle imager, and may facilitate easy synchronization of the imagers 318 among themselves and with the processor 328. Separate reset lines 334 may enable individual communication with a specific imager by holding reset lines 334 of all other imagers TRUE.

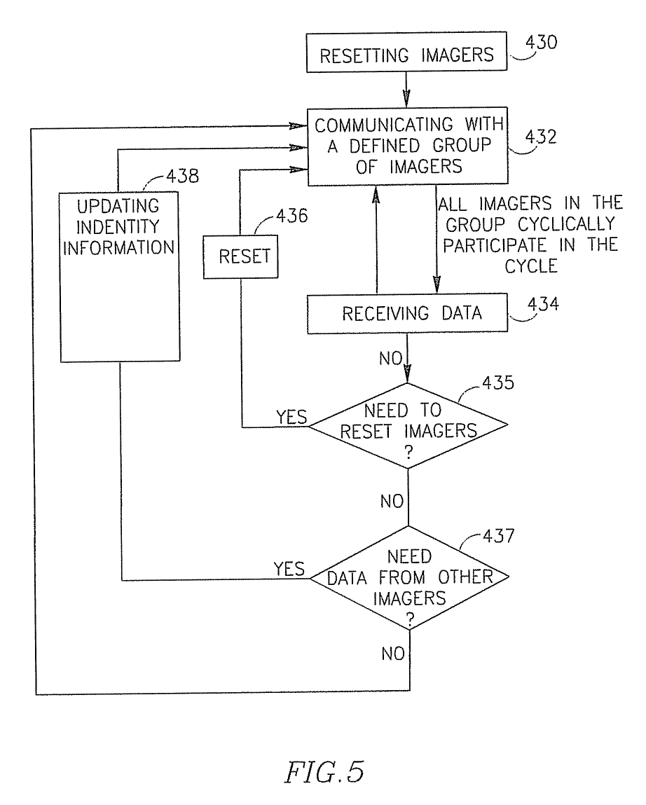

Reference is made to FIG. 5, which is a flow chart illustrating a synchronization and data transfer sequence according to some embodiments of the present invention. The usage of the common data and control buses 330, 332 may require synchronization of the imagers 318 in order to avoid confusion A nonbinding example of a communication sequence implementing this requirement may be as follows:
(v) reset all imagers 318 (step 430).
(vi) communicate and receive data (steps 432 and 434) cyclically from each of the imagers 318 in a group of imagers using the identity, information associated with the imagers 318 of said group;
(vii) if one or more imagers of the group of imagers needs to be reset (step 435), reset those imagers and return to (ii) (step 436);
(viii) if data from other imagers is needed (step 437), update the identity information and return to (ii) (step 438). If data from other imagers is not needed then return to (ii).

Any group of imagers ma) consist of at least one imager.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

1. An in-vivo imaging device comprising:
a plurality of imagers;
a processor;
a single control bus to which each one of the plurality of imagers and the processor are coupled, for communicating control signals from the processor to the plurality of imagers; and
a single data bus to which each one of the plurality of imagers and the processor are coupled, for communicating data between the processor and the plurality of imagers.

2. The system according to claim 1, further comprising a separate reset line connecting between each imager and the processor, for resetting each imager separately.

3. The system according to claim 1, further comprising a single reset line connecting between all the imagers and the processor, for resetting all imager the imagers simultaneously.

4. In an in-vivo imaging device comprising a processor and a plurality of imagers, a method for communicating between the processor and the plurality of imagers comprising the steps of:
providing a control bus;
connecting each imager and the processor to the control bus;
associating with each imager identity information for uniquely identifying each imager; and
communicating control commands and associated identity information from the processor to the imagers.

5. The method of claim 4, wherein the processor communicates with the imagers cyclically.

6. The method of claim 4, further comprising the step of:
providing a data bus;
connecting each imager and the processor to the data bus; and
communicating data and associated identity information between the processor and the imagers.

7. The method of claim 6, wherein the data is communicated cyclically between the processor and the imagers.

8. The method of claim 6, further comprising the steps of:
providing a separate reset line between each imager and the processor, for resetting each imager separately; and
resetting the imagers separately prior to the step of communicating data between the processor and the imagers.

9. The method of claim 6, further comprising the steps of:
providing a single reset line between the imagers and the processor, for resetting the imagers; and
resetting all the imagers simultaneously prior to the step of communicating data between the processor and the imagers.
